(19) United States
(12) Patent Application Publication
(10) Pub. No.: US 2020/0067450 A1
(43) Pub. Date: Feb. 27, 2020

(54) SOLAR SHINGLES

(71) Applicant: Sunflare Co., Chino, CA (US)

(72) Inventor: Paul Vela, Pasadena, CA (US)

(21) Appl. No.: 16/515,148

(22) Filed: Jul. 18, 2019

Related U.S. Application Data
(60) Provisional application No. 62/723,263, filed on Aug. 27, 2018.

(51) Int. Cl. H02S 20/25; E04D 1/30; E04D 1/20

(52) U.S. Cl. CPC H02S 20/25; E04D 2001/308; E04D 1/20; E04D 1/30

(57) ABSTRACT

One solar shingle system includes a first solar shingle device and a second solar shingle device. The first solar shingle device includes one or more photovoltaic cells, a first pair of first solar shingle device connectors, and a second pair of first solar shingle device connectors. The second solar shingle device includes one or more photovoltaic cells, and a first pair of second solar shingle device connectors. A first shingle connector of the second pair of first solar shingle device connectors is configured to electrically connect to a first shingle connector of the first pair of second solar shingle device connectors and a second shingle connector of the second pair of first solar shingle device connectors is configured to electrically connect to a second shingle connector of the first pair of second solar shingle device connectors.

### CROSS-REFERENCE TO RELATED APPLICATION

This application claims the benefit of U.S. provisional patent application No. 62/723,263, filed Aug. 27, 2018.

### TECHNICAL FIELD

This disclosure relates generally to solar shingle devices, systems, and methods, for instance for application on a roof or other suitable exterior structure to convert sunlight into electrical energy.

### BACKGROUND

Solar panels are used to convert sunlight into electrical energy. However, installation of traditional solar panels can be labor-intensive and costly due to the size and weight of traditional panels as well as the need to interconnect wiring between each such traditional panel. Moreover, the resulting layout and appearance of such traditional panels when installed, such as on the roof of a home, may be unappealing. While reducing the size of traditional solar panels may reduce the weight of each individual traditional solar panel, this may act to increase the number of wiring interconnections needed amongst these traditional solar panels.

### SUMMARY

In general, various exemplary embodiments of solar shingle devices, systems, and methods are disclosed herein. Such exemplary embodiments may increase the ease and efficiency of installing a solar power generation system thus reducing the costs associated with solar power generation. And, at the same time, these exemplary embodiments may provide an installed arrangement imitating the appearance of traditional roofing shingles such that the installed arrangement may be more appealing than that otherwise associated with traditional solar panels. In one example, two or more solar shingle devices can be electrically connected together without wiring or cables extending between these solar shingle devices. In particular, the solar shingle devices may be electrically connected together at one or more corresponding shingle connectors located on the interfacing solar shingle devices. Such shingle connectors, as described further herein, may facilitate a direct connection between two interfacing shingle devices without interconnected wiring extending out from such interfacing shingle devices.

One exemplary embodiment includes a solar shingle system. This solar shingle system embodiment includes a first solar shingle device and a second solar shingle device that is configured to electrically connect to the first solar shingle device. The first solar shingle device includes one or more photovoltaic cells, a first pair of first solar shingle device connectors that includes a first shingle connector and a second shingle connector, and a second pair of first solar shingle device connectors that includes a first shingle connector and a second shingle connector. The second solar shingle device includes one or more photovoltaic cells, and a first pair of second solar shingle device connectors that includes a first shingle connector and a second shingle connector. The first shingle connector of the second pair of first solar shingle device connectors is configured to electrically connect to the first shingle connector of the first pair of second solar shingle device connectors. The second shingle connector of the second pair of first solar shingle device connectors is configured to electrically connect to the second shingle connector of the first pair of second solar shingle device connectors.

In a further exemplary embodiment of the solar shingle system, the shingle connectors of the first and second solar shingle devices can have corresponding structures for the electrical connection thereat. The first shingle connector of the second pair of first solar shingle device connectors can include a base of the first shingle connector of the second pair of first solar shingle device connectors, a tab extending out from the base of the first shingle connector of the second pair of first solar shingle device connectors, and a lip extending out from the tab. The first shingle connector of the first pair of second solar shingle device connectors can include a base of the first shingle connector of the first pair of second solar shingle device connectors defining a perimeter, a tab extending out from the base the first shingle connector of the first pair of second solar shingle device connectors at a location offset from the base the first shingle connector of the first pair of second solar shingle device connectors, and a flange defined between the tab and the perimeter. The flange can be configured to receive the lip to electrically connect the first shingle connector of the second pair of first solar shingle device connectors to the first shingle connector of the first pair of second solar shingle device connectors. In one example, the lip can extend out from the tab at an end of the tab that is opposite the base of the first shingle connector of the second pair of first solar shingle device connectors in a direction perpendicular to the tab. And, in some cases, a slot can be defined at the base of the first shingle connector of the second pair of first solar shingle device connectors and/or at the base of the first shingle connector of the first pair of second solar shingle device connectors.

A further exemplary embodiment of the solar shingle system can include an end cap. The end cap can include a first pair of end cap solar shingle device connectors that includes a first shingle connector and a second shingle connector. The first shingle connector of the first pair of end cap solar shingle device connectors can be configured to electrically connect to the first shingle connector of the first pair of first solar shingle device connectors and the second shingle connector of the first pair of end cap solar shingle device connectors can be configured to electrically connect to the second shingle connector of the first pair of first solar shingle device connectors. In one such example, the end cap can include an electrical connector that is configured to connect to an electrical wire to convey electrical energy generated by each of the first solar shingle device and the second solar shingle device.

In various such embodiments, the solar shingle system can include a direct electrical connection between the first solar shingle device and the second solar shingle device. For example, the second solar shingle device can be configured to directly electrically connect to the first solar shingle device by direct contact between the first shingle connector of the second pair of first solar shingle device connectors and the first shingle connector of the first pair of second solar shingle device connectors and direct contact between the second shingle connector of the second pair of first solar shingle device connectors and the second shingle connector of the first pair of second solar shingle device connectors.

Another exemplary embodiment includes a solar shingle device. This solar shingle device embodiment includes a first side and a second side that is opposite the first side. The first side has one or more photovoltaic cells and a first pair of first solar shingle device connectors that includes a first shingle connector and a second shingle connector. The second side has a second pair of first solar shingle device connectors that includes a first shingle connector and a second shingle connector. The first shingle connector of the second pair of first solar shingle device connectors is configured to electrically connect to a first shingle connector of a first pair of second solar shingle device connectors and the second shingle connector of the second pair of first solar shingle device connectors is configured to electrically connect to a second shingle connector of the first pair of second solar shingle device connectors.

### BRIEF DESCRIPTION OF DRAWINGS

The following drawings are illustrative of particular examples of the present invention and therefore do not limit the scope of the invention. The drawings are not necessarily to scale and are intended for use in conjunction with the explanations in the following detailed description. Examples of the present invention will hereinafter be described in conjunction with the appended drawings.

FIG. 1 is a perspective view of an exemplary embodiment of a solar shingle system applied to an exterior roof.

FIG. 2 is a perspective view of an exemplary embodiment of a solar shingle system in isolation.

FIGS. 3A-3C show an exemplary embodiment of a solar shingle system including an exemplary embodiment of an end cap applied at a region thereof. In particular, FIGS. 3A and 3B are perspective views of the solar shingle system including one end cap thereat and another end cap in an exploded view. FIG. 3C is a close-up perspective view of an exemplary embodiment of an electrical connector of the end cap.

FIGS. 4A-4C show perspective views of an exemplary embodiment of individual solar shingle devices. In particular, FIG. 4A is a perspective view of a first side of each of a first and a second solar shingle. FIG. 4B is a perspective view of a second opposite side of each of the first and second solar shingle. FIG. 4C is a perspective view illustrating a connection between the first and second solar shingle.

FIGS. 5A-5C show an exemplary embodiment of shingle connectors of a solar shingle device. In particular, FIG. 5A is a perspective view of a first shingle connector and a second shingle connector in isolation. FIG. 5B is a perspective view of the first shingle connector and the second shingle connector on the solar shingle device. FIG. 5C is a cross-sectional view of a connection between a first shingle connector on one solar shingle device and a second shingle connector on another solar shingle device.

FIG. 6 is a perspective view of an exemplary embodiment of a solar shingle system installation.

FIG. 7 is a flow diagram of an exemplary embodiment of a method for installing a solar shingle system.

### DETAILED DESCRIPTION

The details of one or more examples are set forth in the accompanying drawings and the description below. Like reference numerals are used to convey like features. Other features, objects, and advantages will be apparent from the description and drawings, and from the listing of exemplary embodiments. The following detailed description is exemplary in nature and is not intended to limit the scope, applicability, or configuration of the invention in any way. Rather, the following description provides some practical illustrations for implementing examples of the present invention. Those skilled in the art will recognize that many of the noted examples have a variety of suitable alternatives.

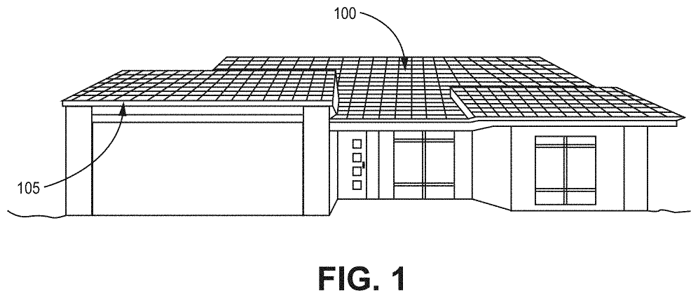

FIG. 1 illustrates a perspective view of an exemplary embodiment of a solar shingle system 100. As shown in the example in FIG. 1, the solar shingle system 100 is applied to an exterior roof 105 of a building. The solar shingle system 100 can form the exterior-most surface of the roof 105 and may mimic or imitate the visual appearance of traditional roofing shingles at such surface. In this example, the solar shingle system 100 overlays substantially all of the surface area of the roof 105 similar to the manner in which traditional roofing shingles would be applied to the roof 105 of the building. Though, depending on the application, the solar shingle system 100 can be applied to overlay less than an entire surface area of the roof 105, including targeted portions of the surface area of the roof 105 along with traditional roofing shingles at other regions of the roof 105.

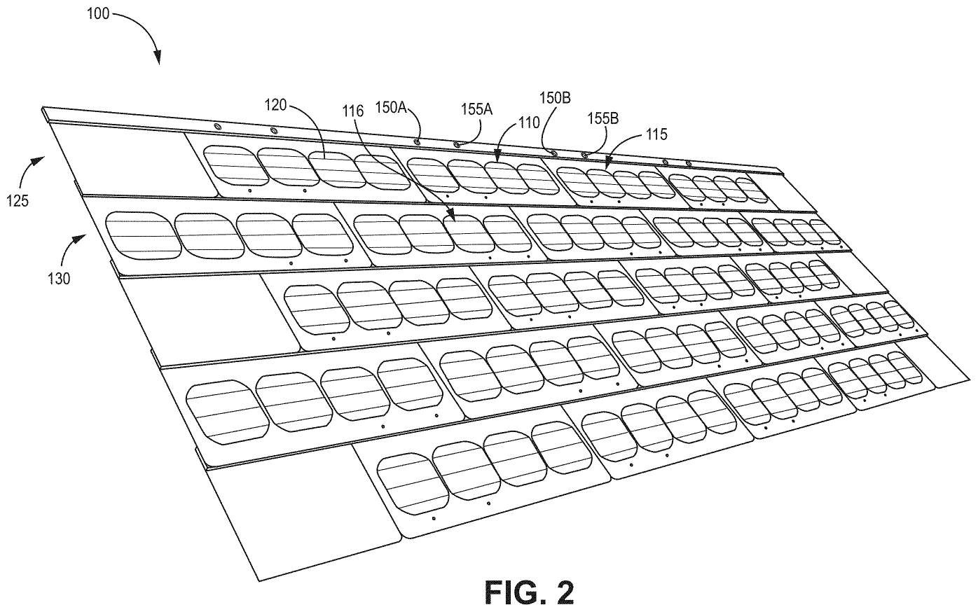

FIG. 2 illustrates a perspective view of the exemplary embodiment of the solar shingle system 100 in isolation. As shown here, the solar shingle system 100 can include a number of individual solar shingle devices, including a first solar shingle device 110, a second solar shingle device 115, and a third solar shingle device 116. As explained in more detail herein, the two or more (e.g., each) of the solar shingle devices 110, 115, 116 can be connected together to form the solar shingle system 100. In particular, in the illustrated embodiment, the solar shingle devices 110, 115 extend (e.g., along a common axis as shown here) to form a first row 125 of solar shingles and a number of other solar singles, including the solar shingle device 116, can extend (e.g., along another common axis as shown here) to form a second row 130 below the first row 125. In some cases, to mimic traditional roofing shingles, the solar shingle devices 110, 115 in the first row 125 can extend over a portion of the solar shingles, including a portion of the solar shingle device 116, in the second row 130. For instance, the respective interfacing portion of the solar shingle devices in the first row 125 and/or the second row 130 can include a gasket with an adhesive material, such as butyl, thereat to facilitate securing the solar shingle devices in place. This arrangement can be repeated over a number of other rows to create the solar shingle system 100 with system dimensions as suitable for a particular application of the solar shingle system 100.

In various embodiments, the solar shingle system 100 may allow the solar shingle devices 110, 115, 116 to be electrically connected together without wiring or cables extending between the first solar shingle device 110, the second solar shingle device 115, and the third solar shingle device 116. In particular, the solar shingle system 100 may allow two or more (e.g., each) of the solar shingle devices 110, 115, 116 to be electrically connected together at one or more corresponding shingle connectors located on interfacing shingle devices. Such shingle connectors, as described further herein, may facilitate a direct connection between two interfacing shingle devices (e.g., the first shingle device 110 and the third single device 116) without interconnected wiring extending out from such interfacing shingle devices. Accordingly, the solar shingle system 100 can facilitate an easier installation, thereby reducing costs associated with solar power generation. And, in many cases, the solar shingle system 100 may provide an aesthetically appealing design.

Each solar shingle device 110, 115, 116 in the system 100 can include one or more photovoltaic cells 120. In the illustrated example, each solar shingle device is shown to have four photovoltaic cells 120, though in other examples the number of photovoltaic cells 120 on any particular solar shingle device can vary as appropriate for the application. As one example, each of the photovoltaic cells 120 can be a copper indium gallium selenide thin-film solar cell (“CIGS” thin-film cell). Each photovoltaic cell 120 can convert sunlight into electrical energy and, as such, the solar shingle system 100 can function to generate electrical energy from sunlight at the solar shingle devices 110, 115, 116 of the system 100. The electrical energy generated at each photovoltaic cell 120 can be transmitted through the electrical connections amongst the solar shingle devices 110, 115, 116 to one or more common points in the solar shingle system 100 where one or more pairs of connectors 150A, 155A and/or 150B, 155B can be present to output the electrical energy generated by each of the solar shingle devices 110, 115, 116. As noted, the generated electrical energy at each solar shingle device 110, 115, 116 can be conveyed from solar shingle device to solar shingle device via the electrical connection therebetween without requiring wiring or cables between adjacent solar shingle devices to convey the electrical energy. Thus, as one example, the electrical energy generated by the photovoltaic cells 120 at the third solar shingle device 116 can be conveyed to the first solar shingle device 110 via the electrical connection between the third solar shingle device 116 and the first solar shingle device 110 and a set of connectors 150A, 155A at the first solar shingle device 110 can serve as a connection point where electrical energy generated by the third solar shingle device 116 and the first solar shingle device 110 can be output.

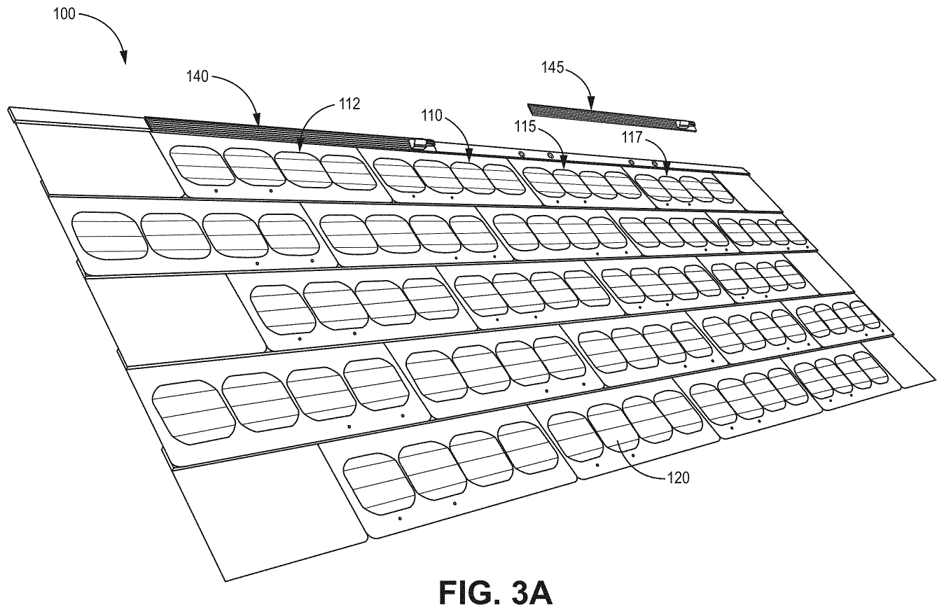

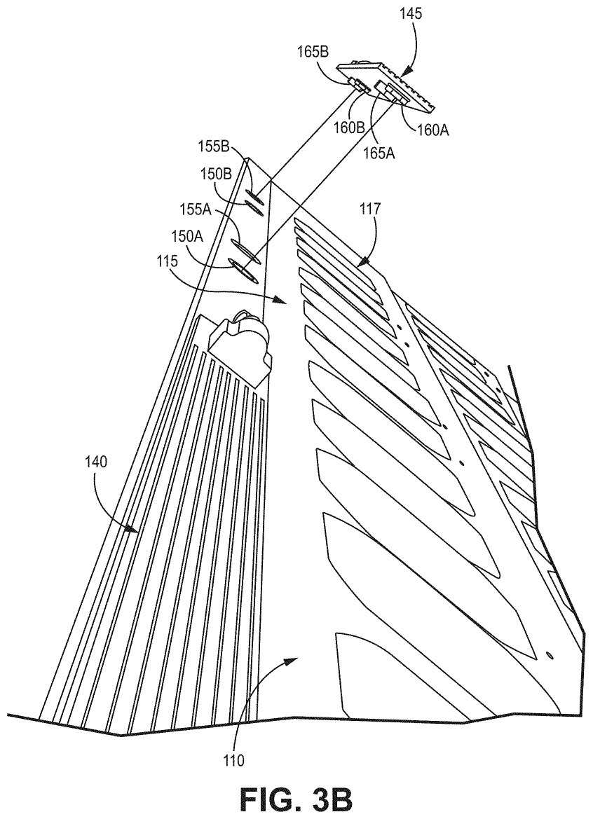

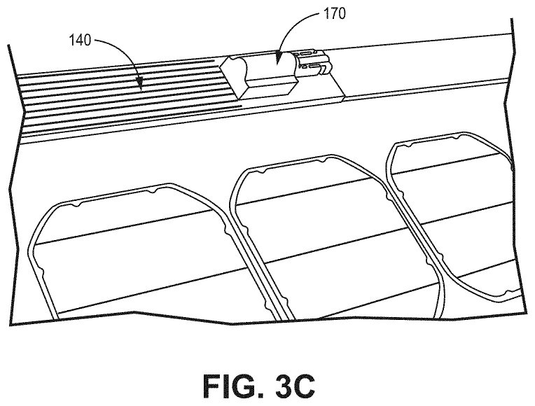

FIGS. 3A-3C show the solar shingle system 100 including an exemplary embodiment of an end cap 140. As shown in FIGS. 3A and 3B, the end cap 140 can be attached to one or more solar shingle devices at an end portion, such as at or near a perimeter, of the solar shingle system 100. The end cap 140 can electrically connect to one or more (e.g., each) of the solar shingle devices at this end portion of the solar shingle system 100, and thus also indirectly electrically connect to those solar shingle devices at other portions of the solar shingle system that are electrically connected to the solar shingle devices at this end portion, and serve as a connection point to output electrical energy generated by the solar shingle system 100. The illustrated embodiment shows the end cap 140 electrically attached to the first solar shingle device 110 and another adjacent solar shingle device 112. A second end cap 145 can be attached to the second solar shingle device 115 and another adjacent solar shingle device 117. Thus, the first end cap 140 can serve as a connection point for electrical energy to be output from the solar shingle devices 110, 112 as well as those solar shingle devices electrically connected to the solar shingle devices 110, 112. Likewise, the second end cap 145 can serve as a connection point for electrical energy to be output from the solar shingle devices 115, 117 as well as those solar shingle devices electrically connected to the solar shingle devices 115, 117.

For instance, FIG. 3B, illustrates one embodiment of an electrical connection between the end caps 140, 145 and the respective solar shingle devices. As shown here, the solar shingle devices can include a first shingle connector 150A and a second shingle connector 155A as is shown for the solar shingle device 115. The first shingle connector 150A can be a first polarity and the second shingle connector 155A can be a second opposite polarity, for example one of the first and second shingle connectors 150A, 155A can be a positive polarity and the other of first and second shingle connectors 150A, 155A can be a negative polarity. The one or more end caps can have corresponding shingle connectors configured to electrically connect to the respective solar shingle device. As shown herein, the end cap 145 has a first pair of end cap solar shingle device connectors that includes a first shingle connector 160A and a second shingle connector 165A for electrically connecting to the corresponding first shingle connector 150A and second shingle connector 155A of the solar shingle 115. The end cap 145 can also include a second pair of end cap solar shingle device connectors that includes a first shingle connector 160B and a second shingle connector 165B for electrically connecting to the corresponding first shingle connector 150B and second shingle connector 155B of the solar shingle device 117. The first shingle connector 160A, 160B on the end cap 145 can be the same polarity as the corresponding first shingle connector 150A, 150B on the corresponding solar shingle device 115, 117 and the second shingle connector 165A, 165B on the end cap 145 can be the same polarity of the corresponding second shingle connector 155A, 155B on the corresponding solar shingle device 115, 117.

When the end caps 140, 145 are connected to the respective solar shingle devices, generated electricity can be output therefrom. FIG. 3C shows an exemplary embodiment of an electrical connector 170. The electrical connector 170 can be configured to connect to an electrical wire or cable to convey electrical energy generated by the solar shingle devices electrically connected to the corresponding end cap. For instance, the electrical connector 170 can in one embodiment be in the form of a universal solar connection, such as a multi-contact four millimeter diameter contact pin (MC4) connector, at which a wire is connected and used to convey generated electrical energy from the system 100 for use at another location.

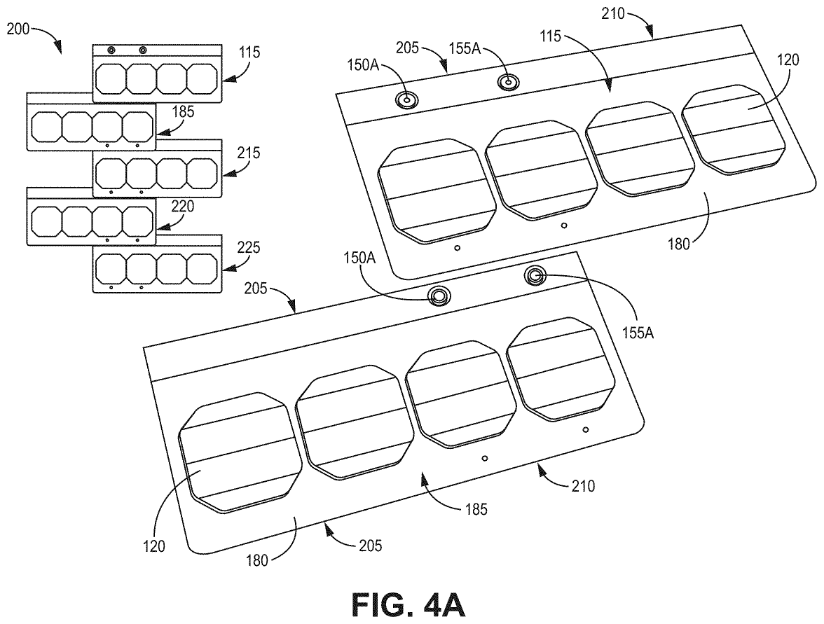

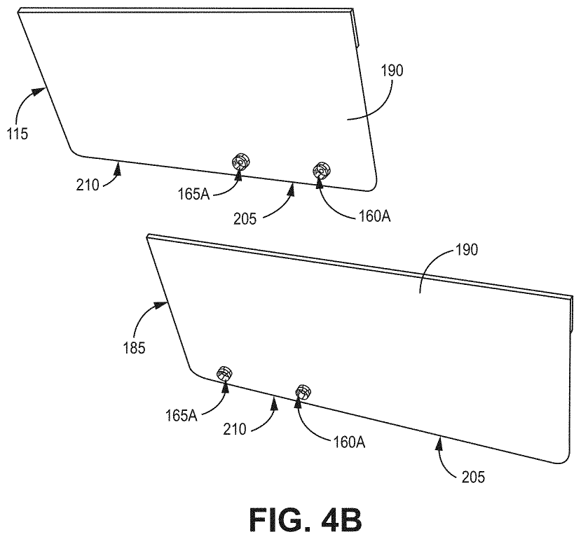

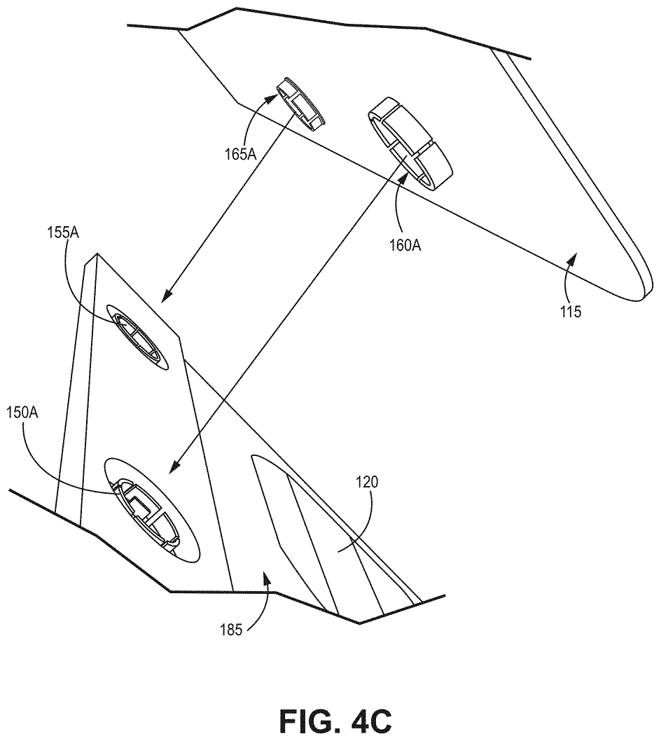

FIGS. 4A-4C show perspective views of an exemplary embodiment of individual solar shingle devices. In particular, FIG. 4A is a perspective view of a first side 180 of each of the solar shingle device 115 and another solar shingle device 185. FIG. 4B shows a perspective view of a second opposite side 190 of each of the solar shingle device 115 and the solar shingle device 185. FIG. 4C is a perspective view illustrating a connection between the solar shingle device 115 and the solar shingle device 185. In one example, each solar shingle device in an embodiment of a solar shingle system can include one or more of (e.g., each of) the features disclosed herein with respect to the solar shingle devices 115, 185.

The solar shingle devices 115, 185 can each include two pairs of solar shingle device connectors. In addition to one or more photovoltaic cells 120, the first side 180 of each solar shingle device 115, 185 can include a first pair of shingle connectors shown here as the first shingle connector 150A and the second shingle connector 155A. The second side 190 of each solar shingle device 115, 185 can include a second pair of shingle connectors shown here as the first shingle connector 160A and the second shingle connector 165A. The solar shingle devices 115, 185 can be electrically connected by connecting i) the first shingle connector 160A at the second side 190 of the first solar shingle device 115 to the first shingle connector 150A at the first side 180 of the second solar shingle device 185 and ii) the second shingle connector 165A at the second side 190 of the first solar shingle device 115 to the second shingle connector 155A at the first side 180 of the second solar shingle device 185. Thus, the second solar shingle device 185 can be configured to directly electrically connect to the solar shingle device 115 by direct contact between the first shingle connector 160A of the second pair of solar shingle device 115 connectors and the first shingle connector 150A of the first pair of solar shingle device 185 connectors and direct contact between the second shingle connector 165A of the second pair of solar shingle device 115 connectors and the second shingle connector 155A of the first pair of solar shingle device 185 connectors. As shown in the illustrated embodiment, a portion the solar shingle device 115 having the second pair of first solar shingle device connectors 160A, 165A can overlay a portion of the solar shingle device 185 having the first pair of second solar shingle device connectors 150A, 155A.

In some examples, the solar shingle devices may be configured to as to connect in a generally staggered arrangement. One example of a staggered arrangement 200 of solar shingle devices 115, 185, 215, 220, 225 is shown in FIG. 4A. In this example, to facilitate the staggered arrangement 200, the electrical connection between solar shingle devices can take place at alternating side portions of the solar shingle devices. In the illustrated embodiment, the solar shingle devices 115, 185 have each of the two pairs of shingle connectors on opposite side portions relative to one another. As shown in FIGS. 4A and 4B, the solar shingle device 115 includes the first shingle connector 150A and the second shingle connector 155A as well as the first shingle connector 160A and the second shingle connector 165A at a first lateral half 205. And, as also shown here, the solar shingle device 185 includes the first shingle connector 150A and the second shingle connector 155A as well as the first shingle connector 160A and the second shingle connector 165A at a second opposite lateral half 210. Likewise, other solar shingle devices 215, 220, 225 can also be electrically connected together at the corresponding, staggered pairs of shingle connectors to create the staggered arrangement 200 of a number of electrically connected solar shingle devices. Thus, as shown in the staggered arrangement 200 in FIG. 4A viewed at a first side, a left lateral half of the solar shingle device 115 is electrically connected to a right lateral half of the solar shingle device 185, the right lateral half of the solar shingle device 185 is electrically connected to a left lateral half of the solar shingle device 215, the left lateral half of the solar shingle device 215 is electrically connected to a right lateral half of the solar shingle device 220, and the right lateral half of the solar shingle device 220 is electrically connected to a left lateral half of the solar shingle device 225. In one example, the last solar shingle device 225 in the arrangement 200 may not have a pair of connectors on the end opposite that where it connects to the solar shingle device 220. And, other similar staggered arrangements can be arranged side-by-side with the staggered arrangement 200 to create rows of solar devices spanning a desired length in a solar shingle system. In such an example, the solar shingle devices in one particular staggered arrangement (e.g., 115, 185, 215, 220, 225 in the arrangement 200) can be electrically connected together and collectively provide electrical energy output at an end cap attached at a solar shingle device (e.g., the solar shingle device 115) at the end of the arrangement. Such an arrangement may be useful in creating an aesthetic appearance that mimics the appearance of traditional roofing shingles.

FIG. 4C shows an electrical connection between the solar shingle device 115 and the solar shingle device 185. As noted, the solar shingle devices 115, 185 can be electrically connected by connecting i) the first shingle connector 160A of the first solar shingle device 115 to the first shingle connector 150A of the second solar shingle device 185 and ii) the second shingle connector 165A of the first solar shingle device 115 to the second shingle connector 155A of the second solar shingle device 185. The first shingle connector 160A of the first solar shingle device 115 and the first shingle connector 150A of the second solar shingle device 185 can be of the same polarity and have corresponding structures configured to create a connection, such as an interference fit (e.g., a snap fit), therebetween. Likewise, the second shingle connector 165A of the first solar shingle device 115 and the second shingle connector 155A of the second solar shingle device 185 can be of the same polarity, but opposite polarity of the first shingle connectors 150A, 160A, and have corresponding structures configured to create a connection, such as an interference fit (e.g., a snap fit), therebetween. For example, the first shingle connectors 150A, 160A can be a positive polarity and the second shingle connectors 155A, 165A can be a negative polarity.

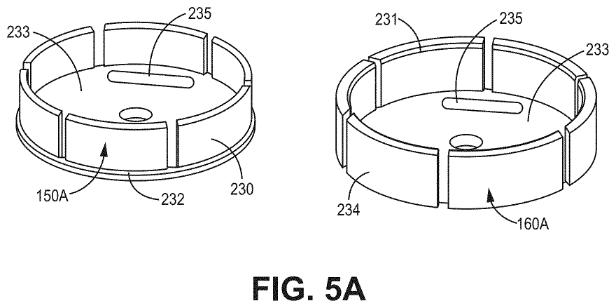

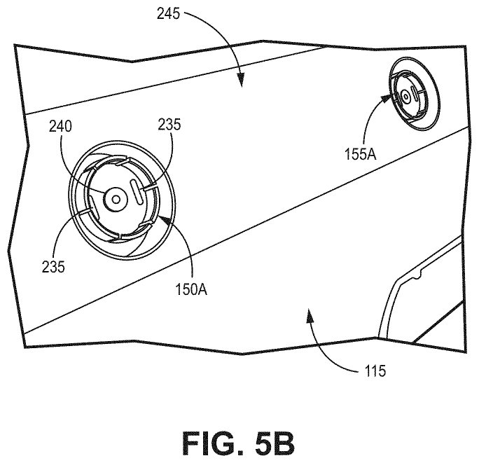

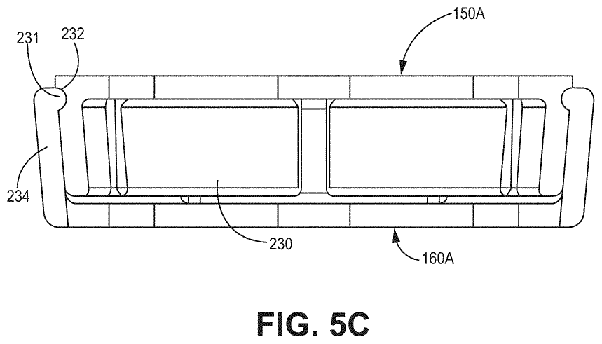

FIGS. 5A-5C show an exemplary embodiment of the first shingle connector 150A and the first shingle connector 160A. The first shingle connectors 150A, 160A can have corresponding, complimentary structures configured to facilitate a mechanical and electrical connection thereat. For instance, in the example here, the first shingle connector 150A can be a male connector while the first shingle connector 160A can be a female connector, though other structural configurations may be used to provide the connection therebetween. As illustrated in the example of FIG. 5A, the first shingle connector 150A includes a number of tabs 230 extending out from a base 233 and spaced apart around the first shingle connector 150A at a location offset from the perimeter of the base 233 so as to define a flange 232 at the perimeter of the base 233 of the first shingle connector 105A. Thus, the flange 232 can be defined between the tabs 230 and the perimeter of the base 233. As also illustrated in the example of FIG. 5A, the first shingle connector 160A include a number of tabs 234 extending out from a base 233 and spaced apart about around the perimeter of the base 233 of the first shingle connector 160A. The first shingle connector 160A can also include a lip 231 defined on one or more of (e.g., each of) the tabs 234 at or near an end of the one or more tabs 234 that is opposite the base 233 (e.g., an end having the slots 235) of the first shingle connector 160A. The lip 231 can extend out from the one or more tabs 234, for example in a direction generally perpendicular to the one or more tabs 234. In addition, each of the first shingle connectors 150A, 160A includes one or more slots 235 defined at respective bases 233. In the illustrated example, each of the first shingle connectors 150A, 160A include two slots at corresponding locations thereat within an internal area of the base 233 defined by the respective tabs 230, 234.

The second shingle connector 155A can be the same as, or similar to, the first shingle connector 150A and the second shingle connector 165A can be the same as, or similar to, the first shingle connector 160A. Though, in another embodiment, the second shingle connector 155A can be the same as, or similar to, the first shingle connector 160A and the second shingle connector 165A can be the same as, or similar to, the first shingle connector 150A.

FIG. 5B shows a perspective view of the first shingle connector 150A and the second shingle connector 155A on the solar shingle device 115. In one example, an aperture can be present in the first solar shingle device 115 at each of the locations for the first shingle connector 150A and the second shingle connector 155A. A fastener 240, such as a rivet, pin, bolt, screw or other appropriate securement member, can be secured at the aperture in the first solar shingle device 115 and attach the first shingle connector 150A to the first solar shingle device 115. In some cases, the fastener 240 may be made of a non-conductive material while the first shingle connector 150A is made of a conductive material to provide an electrical connection. Each of the other shingle connectors can be secured to the shingle device using the fastener. The one or more slots 235 of the first shingle connector 150A can be aligned with an electrical outlet on the first solar shingle device 115 and serve to facilitate transmission of electrical energy therethrough from the first solar shingle device 115 to an attached connector (e.g., of another solar shingle device, of an end cap) thereat. The second shingle connector 155A can have the same, or similar, features as that described for the first shingle connector 150A.

Also shown in FIG. 5B is a gasket 245 of the solar shingle device 115. The gasket 245 can interface with an overlaid portion of another, connected solar shingle device (e.g., another, connected solar shingle device interfacing in the staggered arrangement described previously). To help secure two solar shingle devices together, the gasket 245 can include an adhesive material thereat to provide a more secured interface with the overlaid portion of the another, connected solar shingle device. For instance, as one example the adhesive at the gasket 245 can include butyl material. As also shown in the illustrated embodiment, the gasket 245 can be located at a portion of the solar shingle device 115 that includes the first shingle connector 150A and the second shingle connector 155A.

FIG. 5C is a cross-sectional view of a connection between the first shingle connector 150A on one solar shingle device and the first shingle connector 160A on another, electrically connected solar shingle device. As shown in the example here, the first shingle connector 150A and the first shingle connector 160A each have a complimentary structure that can be configured to create a mechanical and electrical connection between the solar shingle devices. In the illustrated embodiment, the first shingle connector 150A can have a male connector structural configuration while the first shingle connector 160A can have a female connector structural configuration. In particular, the tabs 230 of the first shingle connector 150A can sit within the tabs 234 (e.g., the internal area of the first shingle connector 160A within the tabs 234) of the first shingle connector 160A. Also, the lip 231 at the tabs 234 of the first shingle connector 160A can be received at the flange 232 of the first shingle connector 150A to provide a connection therebetween. In one example, the lip 231 and the flange 232 can facilitate and interference fit connection, such as a snap fit, between the shingle connectors 150A, 160A. In this way, the lip 231 can sit within the flange 232 when the shingle connectors 150A, 160A are mechanically and electrically connected.

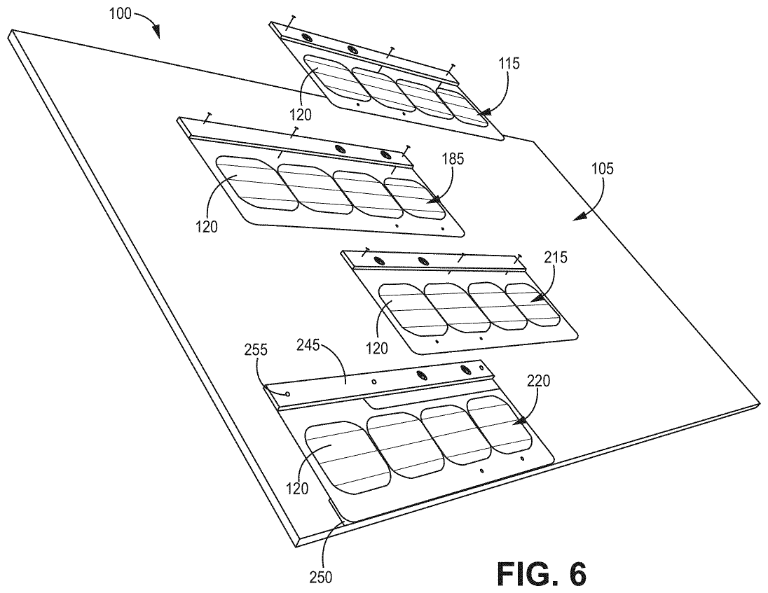

FIG. 6 shows a perspective view of an exemplary embodiment of a solar shingle system 100 installation. Solar shingle device 220 is shown secured to the roof 105 while solar shingle devices 115, 185, and 215 are shown in an exploded installation view.

As noted, a solar shingle system 100 can be installed on a surface of an exterior roof 105 or other suitable exterior support substrate. An adhesive 250 can be used to secure an end portion of a solar shingle device 220 at an end of the arrangement of a number of solar shingle devices in the solar shingle system 100. An opposite end of the solar shingle device 220 can have the gasket 245. The gasket 245 and panel of the solar shingle device 220 upon which the gasket is present can include one or more fastening apertures 255 which can be configured to receive a fastener (e.g., a nail, as shown here, a screw, a bolt, etc.) to secure the solar shingle device 220 to the roof 105 or other suitable substrate. In the illustrated embodiment, each solar shingle device includes three fastening apertures 255 extending through the gasket 245 and solar shingle device, though in other embodiments the solar shingle device can include one, two, four, or more fastening apertures at the gasket 245 and/or other locations on the solar shingle device. As for the fastener which the fastening aperture is configured to receive, for example, in one embodiment a composite nail can be used as the fastener to secure the solar shingle device 220 to the roof 105, or other suitable substrate, at the one or more of the fastening holes 255.

Once the solar shingle device 220 is secured to the roof 105, or other suitable substrate, another solar shingle device 215 can be electrically connected to the solar shingle device 220 at the pair of shingle connectors thereon as detailed previously herein. When the solar shingle device 215 is electrically connected to the solar shingle device 220, adhesive included at the gasket 245 may help to secure an end portion of the solar shingle device 215 thereat. The remaining solar shingle devices (e.g., solar shingle devices 185 and 115) in a particular arrangement of the solar shingle system 100 can similarly be installed and electrically connected to an adjacent solar shingle device. Likewise, additional arrangements of more solar shingle devices can be installed and electrically connected to one another to form a desired span of the solar shingle system 100 as suited for a particular application. And, as noted, one or more end caps can be used at the end of the arrangements within the solar shingle system 100 (e.g., at the gasket of the solar shingle device 115) to provide an electrical output from each of the electrically connected solar shingle devices 220, 215, 185, 115.

Various method embodiments are also within the scope of the present disclosure and such embodiments can incorporate steps relating to any one or more of the features disclosed herein. For example, some such embodiments can include methods of electrically connecting two or more solar shingle devices, methods of installing a solar shingle system, methods of manufacturing a solar shingle device, and methods of generating electrical energy from sunlight.

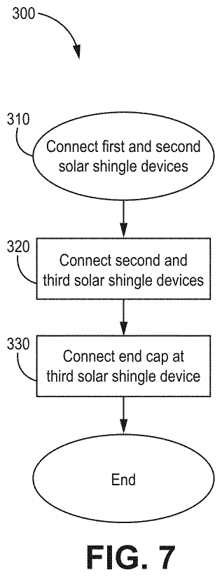

FIG. 7 a flow diagram of an exemplary embodiment of a method 300 for installing a solar shingle system.

At step 310, a second solar shingle device is electrically connected to a first solar shingle device. To do so, as detailed herein, a first shingle connector on the first solar shingle device can be electrically connected to a corresponding first shingle connector on the second solar shingle device and a second shingle connector on the first solar shingle device can be electrically connected to a corresponding second shingle connector on the second solar shingle device. For example, the first shingle connector on the first solar shingle device and the first shingle connector on the second solar shingle device can have the same polarity and can include complimentary mechanical structures that are configured interlock when connected, such as a lip at a tab of one shingle connector sitting in a flange on a tab of the other shingle connector. Likewise, the second shingle connector on the first solar shingle device and the second shingle connector on the second solar shingle device can have the same polarity, opposite the polarity of the first shingle connectors, and can include complimentary mechanical structures that are configured interlock when connected. In some examples, the first and second solar shingle devices can include the corresponding first and second shingle connectors at offset lateral locations such that connecting the first and second solar shingles devices requires an offset arrangement (e.g. an axis through the lateral center of the first solar shingle device does not pass through, or is offset from, the lateral center of the second solar shingle device) of the first and second solar shingle devices.

At step 320, a third solar shingle device is electrically connected to the second solar shingle device. To do so, as detailed herein, a first shingle connector on the third solar shingle device can be electrically connected to a corresponding first shingle connector on the second solar shingle device and a second shingle connector on the third solar shingle device can be electrically connected to a corresponding second shingle connector on the second solar shingle device. Such connection can be similar to that described for connecting the first and second solar shingle devices at step 310. In some examples, the second and third solar shingle devices can include the corresponding first and second shingle connectors at offset lateral locations such that connecting the second and third solar shingles devices requires an offset arrangement (e.g. an axis through the lateral center of the second solar shingle device does not pass through, or is offset from, the lateral center of the third solar shingle device) of the first and second solar shingle devices. Though, in the connected arrangement, it could be the case that the first and third solar shingle devices are aligned (e.g., an axis through the lateral center of the first solar shingle device does pass through the lateral center of the third solar shingle device).

At step 330, an end cap is electrically connected at the third solar shingle device. For example, the end cap can include a first shingle connector and a second shingle connector. The first shingle connector and the second shingle connector of the end cap can be electrically connected to the corresponding first and second shingle connectors at the third solar shingle device. In some further examples, a wire or cable can be connected to an electrical connector of the end cap so as to convey electrical energy generated by each of the first, second, and third solar shingle devices.

As noted, the method 300 can further include steps involving any of the details disclosed herein with respect to the solar shingle system and solar shingle device embodiments.

Various examples have been described with reference to certain disclosed embodiments. The embodiments are presented for purposes of illustration and not limitation. One skilled in the art will appreciate that various changes, adaptations, and modifications can be made without departing from the scope of the invention.

What is claimed is:

1. A solar shingle system comprising:
a first solar shingle device comprising:
one or more photovoltaic cells,
a first pair of first solar shingle device connectors that includes a first shingle connector and a second shingle connector, and
a second pair of first solar shingle device connectors that includes a first shingle connector and a second shingle connector; and
a second solar shingle device configured to electrically connect to the first solar shingle device, the second solar shingle device comprising:
one or more photovoltaic cells, and
a first pair of second solar shingle device connectors that includes a first shingle connector and a second shingle connector,
wherein the first shingle connector of the second pair of first solar shingle device connectors is configured to electrically connect to the first shingle connector of the first pair of second solar shingle device connectors and the second shingle connector of the second pair of first solar shingle device connectors is configured to electrically connect to the second shingle connector of the first pair of second solar shingle device connectors.

2. The solar shingle system of claim 1,
wherein the first shingle connector of the second pair of first solar shingle device connectors comprises:
a base of the first shingle connector of the second pair of first solar shingle device connectors,
a tab extending out from the base of the first shingle connector of the second pair of first solar shingle device connectors, and
a lip extending out from the tab,
wherein the first shingle connector of the first pair of second solar shingle device connectors comprises:
a base of the first shingle connector of the first pair of second solar shingle device connectors defining a perimeter,
a tab extending out from the base the first shingle connector of the first pair of second solar shingle device connectors at a location offset from the base the first shingle connector of the first pair of second solar shingle device connectors, and
a flange defined between the tab and the perimeter, wherein the flange is configured to receive the lip to electrically connect the first shingle connector of the second pair of first solar shingle device connectors to the first shingle connector of the first pair of second solar shingle device connectors.

3. The solar shingle system of claim 2, wherein the lip extends out from the tab at an end of the tab that is opposite the base of the first shingle connector of the second pair of first solar shingle device connectors, wherein the lip extends out from the tab in a direction perpendicular to the tab, and wherein a slot is defined at the base of the first shingle connector of the second pair of first solar shingle device connectors.

4. The solar shingle system of claim 1, wherein the first shingle connector of the second pair of first solar shingle device connectors and the first shingle connector of the first pair of second solar shingle device connectors are configured to be of a first polarity, and wherein the second shingle connector of the second pair of first solar shingle device connectors and the second shingle connector of the first pair of second solar shingle device connectors are configured to be of a second polarity that is different than the first polarity.

5. The solar shingle system of claim 1, wherein the first shingle connector of the second pair of first solar shingle device connectors and the second shingle connector of the second pair of first solar shingle device connectors are each attached to the first solar shingle device by a fastener made of a non-conductive material.

6. The solar shingle system of claim 1, further comprising:
an end cap comprising a first pair of end cap solar shingle device connectors that includes a first shingle connector and a second shingle connector, wherein the first shingle connector of the first pair of end cap solar shingle device connectors is configured to electrically connect to the first shingle connector of the first pair of first solar shingle device connectors and the second shingle connector of the first pair of end cap solar shingle device connectors is configured to electrically connect to the second shingle connector of the first pair of first solar shingle device connectors.

7. The solar shingle system of claim 6, wherein the end cap further comprises an electrical connector that is configured to connect to an electrical wire to convey electrical energy generated by each of the first solar shingle device and the second solar shingle device.

8. The solar shingle system of claim 1, wherein the second solar shingle device is configured to directly electrically connect to the first solar shingle device by direct contact between the first shingle connector of the second pair of first solar shingle device connectors and the first shingle connector of the first pair of second solar shingle device connectors and direct contact between the second shingle connector of the second pair of first solar shingle device connectors and the second shingle connector of the first pair of second solar shingle device connectors.

9. The solar shingle system of claim 1, wherein the first solar shingle device further comprises:
a first side having the one or more photovoltaic cells and the first pair of first solar shingle device connectors, and
a second side that is opposite the first side, the second side having the second pair of first solar shingle device connectors.

10. The solar shingle system of claim 9, wherein a portion the first solar shingle device having the second pair of first solar shingle device connectors overlays a portion of the second solar shingle device having the first pair of second solar shingle device connectors.

11. The solar shingle system of claim 1, wherein the first solar shingle device includes the second pair of first solar shingle device connectors at a first lateral half of the first solar shingle device, and wherein the second solar shingle device includes the first pair of second solar shingle device connectors at a second lateral half of the second solar shingle device that is opposite the first lateral half of the first solar shingle device.

12. The solar shingle system of claim 11, wherein the second pair of first solar shingle device connectors of the first solar shingle device is configured to electrically connect to the first pair of second solar shingle device connectors of the second solar shingle device so that an axis through a lateral center of the first solar shingle device is offset from a lateral center of the second solar shingle device.

13. The solar shingle system of claim 1, wherein the second solar shingle device further comprises a gasket, wherein the gasket comprises an adhesive material and one or more fastening apertures, and wherein the gasket is located at a portion of the second solar shingle device that includes the first pair of second solar shingle device connectors.

14. The solar shingle system of claim 1, wherein the second solar shingle device further comprises:
a second pair of second solar shingle device connectors that includes a first shingle connector and a second shingle connector.

15. The solar shingle system of claim 14, further comprising:
a third solar shingle device comprising:
one or more photovoltaic cells, and
a first pair of third solar shingle device connectors that includes a first shingle connector and a second shingle connector,
wherein the first shingle connector of the second pair of second solar shingle device connectors is configured to electrically connect to the first shingle connector of the first pair of third solar shingle device connectors and the second shingle connector of the second pair of second solar shingle device connectors is configured to electrically connect to the second shingle connector of the first pair of third solar shingle device connectors.

16. A solar shingle device comprising:
a first side having one or more photovoltaic cells and a first pair of first solar shingle device connectors that includes a first shingle connector and a second shingle connector; and
a second side that is opposite the first side, the second side having a second pair of first solar shingle device connectors that includes a first shingle connector and a second shingle connector,
wherein the first shingle connector of the second pair of first solar shingle device connectors is configured to electrically connect to a first shingle connector of a first pair of second solar shingle device connectors and the second shingle connector of the second pair of first solar shingle device connectors is configured to electrically connect to a second shingle connector of the first pair of second solar shingle device connectors.

17. The solar shingle device of claim 16, wherein the first shingle connector of the second pair of first solar shingle device connectors comprises:
a base,
a tab extending out from the base,
a slot defined at the base, and
a lip extending out from the tab at an end of the tab that is opposite the base, wherein the lip extends out from the tab in a direction perpendicular to the tab.

18. The solar shingle device of claim 17, wherein the lip is configured to be received at a flange on the first shingle connector of a first pair of second solar shingle device connectors to electrically connect the first shingle connector of the second pair of first solar shingle device connectors to the first shingle connector of the first pair of second solar shingle device connectors.

19. The solar shingle device of claim 16, wherein the solar shingle device is configured to directly electrically connect to a second solar shingle device by direct contact between the first shingle connector of the second pair of first solar shingle device connectors and the first shingle connector of the first pair of second solar shingle device connectors and direct contact between the second shingle connector of the second pair of first solar shingle device connectors and the second shingle connector of the first pair of second solar shingle device connectors.

20. The solar shingle device of claim 16, further comprising:
an end cap comprising a first pair of end cap solar shingle device connectors that includes a first shingle connector and a second shingle connector,
wherein the first shingle connector of the first pair of end cap solar shingle device connectors is configured to electrically connect to the first shingle connector of the first pair of first solar shingle device connectors and the second shingle connector of the first pair of end cap solar shingle device connectors is configured to electrically connect to the second shingle connector of the first pair of first solar shingle device connectors, and
wherein the end cap further comprises an electrical connector that is configured to connect to an electrical wire to convey electrical energy generated by the first solar shingle device.
